(19) United States
(12) Patent Application Publication
(10) Pub. No.: US 2017/0356316 A1
(43) Pub. Date: Dec. 14, 2017

(54) GAS-LIQUID SEPARATION DEVICE FOR BLOW-BY GAS IN ENGINE

(71) Applicant: YAMAHA HATSUDOKI KABUSHIKI KAISHA, Iwata-shi (JP)

(72) Inventor: Katsuhiro SUZUKI, Shizuoka (JP)

(21) Appl. No.: 15/617,058

(22) Filed: Jun. 8, 2017

(30) Foreign Application Priority Data
Jun. 10, 2016 (JP) 2016-115970

(51) Int. Cl. F01M 13/04; B01D 45/06; F01M 11/02; F01M 13/02; F02M 35/10; F02F 1/42

(52) U.S. Cl. CPC F01M 13/04; F02M 35/10222; F02F 1/42; F01M 11/02; F01M 13/021; B01D 45/06; F01M 2013/0488

(57) ABSTRACT

A gas-liquid separation device includes a gas-liquid separation chamber in a head cover that defines a valve gear chamber, a partition wall that changes a direction of blow-by gas that flows in the gas-liquid separation chamber, and a blow-by gas suction passage extending from the gas-liquid separation chamber to an intake-side valve gear chamber. The upstream end of the blow-by gas suction passage defines an opening in a vicinity of a bottom wall of the valve gear chamber (intake-side valve gear chamber). The gas-liquid separation device removes an oil mist in the blow-by gas while using a compact and simple gas-liquid separation structure.

### CROSS REFERENCE TO RELATED APPLICATIONS

This application claims the benefit of priority to Japanese Patent Application No. 2016-115970 filed on Jun. 10, 2016. The entire contents of this application are hereby incorporated herein by reference.

### BACKGROUND OF THE INVENTION

As a gas-liquid separation device for blow-by gas in a vehicle engine, conventionally, there exists a device provided in a head cover as described in, for example, Japanese Patent No. 2647951. The engine disclosed in Japanese Patent No. 2647951 is mounted in the engine room of a vehicle. The engine is mounted on a vehicle body in a state in which a cylinder head is located above a cylinder block.

The cylinder head of the engine includes a valve gear including an intake valve, an exhaust valve, an intake camshaft, an exhaust camshaft, and the like. The valve gear is housed in a valve gear chamber between the cylinder head and the head cover. The intake valve and the exhaust valve extend through the bottom of the valve gear chamber.

A gas-liquid separation device for blow-by gas is provided on a portion of the head cover facing the bottom of the valve gear chamber and corresponding to an intake camshaft. The gas-liquid separation device for blow-by gas includes a gas-liquid separation chamber separated from the valve gear chamber and extending parallel to the camshaft, and a plurality of partition walls that define a blow-by gas passage having a serpentine shape in the gas-liquid separation chamber. The blow-by gas inlet of the gas-liquid separation chamber defines an opening in the upper portion of the valve gear chamber. On the other hand, the blow-by gas outlet of the gas-liquid separation chamber is connected to an intake air passage via a pipe.

The blow-by gas inlet of the gas-liquid separation chamber defines an opening in the upper portion of the valve gear chamber in a direction toward the cylinder head. For this reason, the negative pressure (to be referred to as an intake negative pressure hereinafter) in the intake air passage is propagated to the blow-by gas passage in the gas-liquid separation chamber via the pipe, and blow-by gas in the valve gear chamber is drawn from the blow-by gas inlet to the gas-liquid separation chamber.

The intake negative pressure is also propagated from the gas-liquid separation chamber to a crank chamber on the cylinder block side via the valve gear chamber. For this reason, the blow-by gas in the crank chamber and mist-like oil particles (to be referred to as an oil mist hereinafter) mixed into the blow-by gas are drawn from the cylinder block side to the valve gear chamber by the negative intake pressure. Due to the momentum of suction to the valve gear chamber, the blow-by gas and the oil mist tend to directly move upward in the valve gear chamber and stay near the blow-by gas inlet of the gas-liquid separation chamber.

On the other hand, in the valve gear chamber, a camshaft rotates at a high speed, and an oil mist is scattered from the valve gear chamber by centrifugal force. A portion of the scattered oil mist is scattered in the vicinity of the blow-by gas inlet in the upper portion of the valve gear chamber, and drawn into the gas-liquid separation chamber via the blow-by gas inlet together with the blow-by gas and oil mist from the cylinder block side.

The blow-by gas drawn into the gas-liquid separation chamber flows through the blow-by gas passage having a serpentine shape. At this time, oil contained in the blow-by gas adheres to the wall surfaces or partition walls of the blow-by gas passage, and the oil is captured. The oil is able to flow from an oil return hole in the bottom of the gas-liquid separation chamber to the valve gear chamber.

In the gas-liquid separation device for blow-by gas in the engine shown in Japanese Patent No. 2647951, the amount of oil mist contained in the blow-by gas drawn into the gas-liquid separation chamber is large. The amount of oil mist probably increases because of the following two phenomena. As the first phenomenon, the oil mist drawn from the cylinder head side to the valve gear chamber readily stays on the upper side of the valve gear chamber. As the second phenomenon, the oil mist that has scattered according to the rotation of the camshaft is also drawn into the blow-by gas inlet.

As a result, in the gas-liquid separation device for blow-by gas in the engine shown in Japanese Patent No. 2647951, the gas-liquid separation chamber needs to be bulky to remove the large amount of oil mist drawn into the gas-liquid separation chamber. There are two reasons. As the first reason, a gas-liquid separation chamber needs to have a large volume to provide a long blow-by gas passage. As the second reason, a complex gas-liquid separation structure needs to be used.

However, in the engine mounted in the engine room of a vehicle, since the height of the head cover is limited by the engine hood, there is a limitation in provided a large gas-liquid separation chamber. In addition, since the complex gas-liquid separation structure requires many parts and man-hours to assemble, the manufacturing cost is high.

### SUMMARY OF THE INVENTION

Preferred embodiments of the present invention provide a gas-liquid separation device for blow-by gas in an engine that is able to remove an oil mist contained in the blow-by gas while using a compact and simple gas-liquid separation structure.

According to a preferred embodiment of the present invention, a gas-liquid separation device for blow-by gas in an engine includes a head cover that defines a valve gear chamber together with a cylinder head, a gas-liquid separation chamber in the head cover and including a blow-by gas inlet and a blow-by gas outlet, a partition wall in the gas-liquid separation chamber to change a direction of blow-by gas that flows between the blow-by gas inlet and the blow-by gas outlet, and a blow-by gas suction passage connected to the blow-by gas inlet and extending from the gas-liquid separation chamber to the valve gear chamber, wherein an upstream end of the blow-by gas suction passage defines an opening in a vicinity of or adjacent to a bottom wall of the valve gear chamber.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view showing an engine including a gas-liquid separation device for blow-by gas in an engine according to a preferred embodiment of the present invention in a state in which a cylinder head is cut away, and a crank case is not illustrated.

FIG. 2 is a side view of the engine.

FIG. 3 is a plan view of a cylinder head, which illustrates only the two ends of the cylinder head.

FIG. 4 is a sectional view of a gas-liquid separation chamber viewed from the axial direction of a crankshaft, a cutaway position thereof is a position indicated by a line IV-IV in FIG. 3.

FIG. 5 is a sectional view of the main portion in FIG. 2 taken along a line V-V.

FIG. 6 is a sectional view of the gas-liquid separation device in FIG. 2 taken along a line VI-VI.

FIG. 7 is a longitudinal sectional view of the gas-liquid separation device along line VII-VII in FIG. 6.

### DETAILED DESCRIPTION OF THE PREFERRED EMBODIMENTS

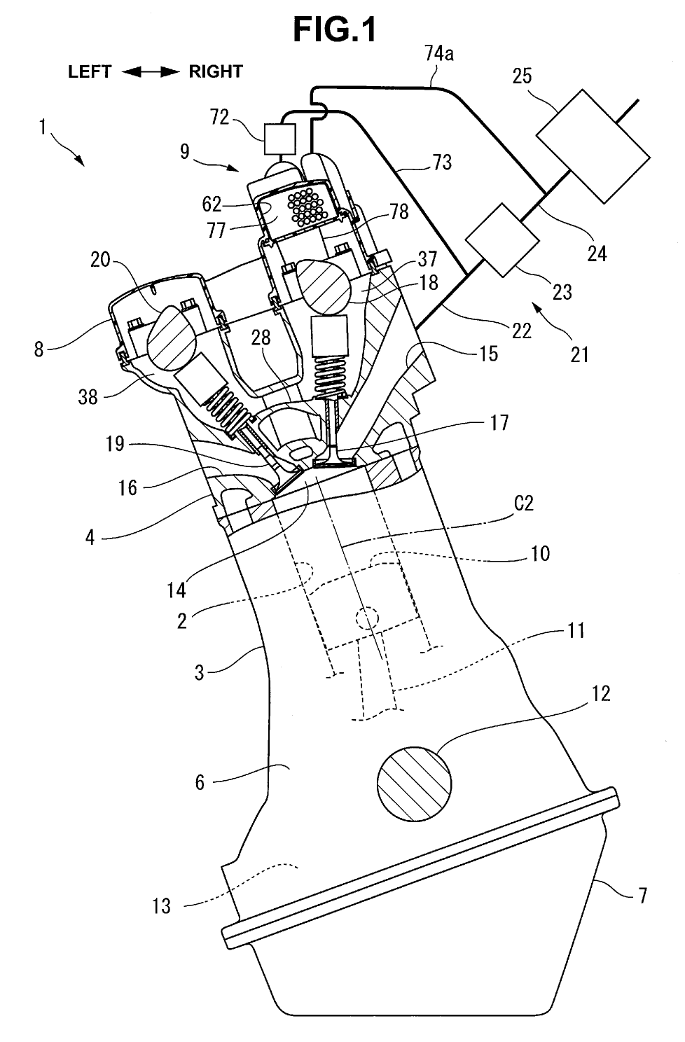

A gas-liquid separation device for blow-by gas in an engine according to preferred embodiments of the present invention will now be described in detail with reference to FIGS. 1 to 7.

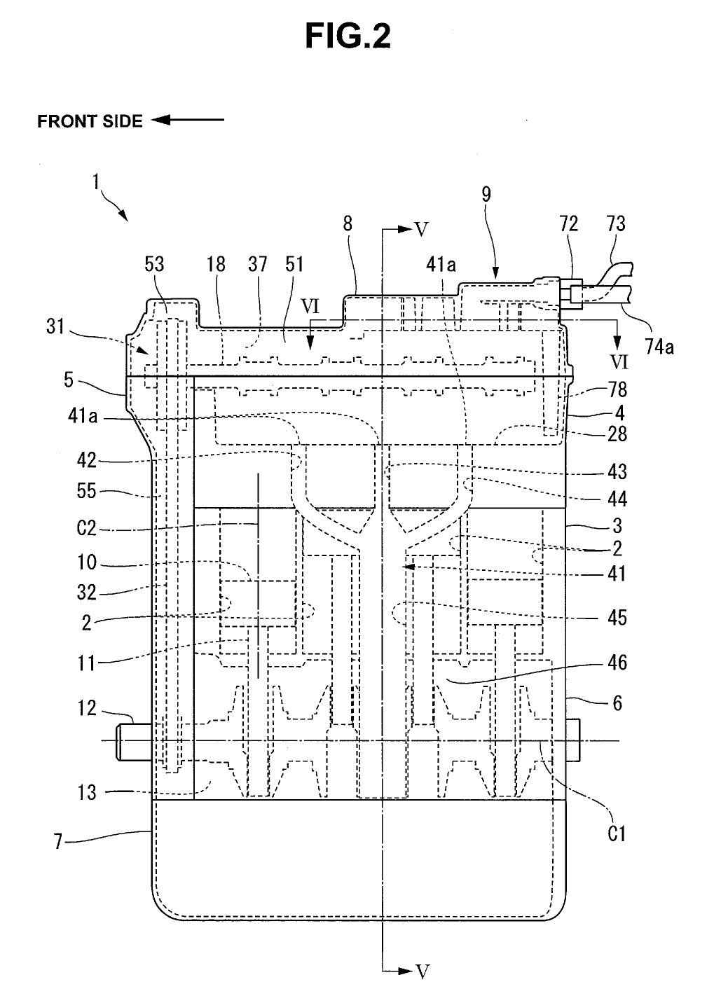

An engine 1 shown in FIG. 1 is preferably a DOHC 4-cylinder engine, for example, mounted on a vehicle. As shown in FIG. 2, the engine 1 includes a cylinder block 3 with four cylinder holes 2, a cylinder head 4 attached to the upper end of the cylinder block 3, a transmission case 5 attached to front ends of the cylinder block 3 and the cylinder head 4, an oil pan 7 attached to a crank case 6 at the lower end of the cylinder block 3, a head cover 8 attached to the upper end of the cylinder head 4, and a gas-liquid separation device 9 for blow-by gas in the head cover 8.

A piston 10 is movably fitted in each of the four cylinder holes 2. Each piston 10 is connected to a crankshaft 12 via a connecting rod 11. As shown in FIG. 1, the crankshaft 12 is housed in a crank chamber 13 located between the crank case 6 and the oil pan 7 and rotatably supported by the crank case 6 (cylinder block 3). An explanation will be made while defining one end side in the axial direction of the crankshaft 12 where the transmission case 5 is located on the front end of the engine 1. In addition, a direction perpendicular to the sheet surface of FIG. 1, that is, a direction perpendicular to an axis C1 of the crankshaft 12 and a cylinder axis C2 will be referred to as the left-and-right direction of the engine 1.

As shown in FIG. 1, the cylinder head 4 includes a concave portion 14 that defines a combustion chamber, and is located at a position corresponding to the cylinder hole 2 of each cylinder. The cylinder head 4 also includes an intake port 15 and an exhaust port 16 that define openings in the concave portion 14. In addition, the cylinder head 4 includes an intake valve 17 and an intake camshaft 18, and an exhaust valve 19 and an exhaust camshaft 20. The intake valve 17 is driven by the intake camshaft 18 to open/close the intake port 15. The exhaust valve 19 is driven by the exhaust camshaft 20 to open/close the exhaust port 16.

The engine 1 according to the present preferred embodiment is mounted in the engine room of a vehicle body (not shown) at an incline such that the intake camshaft 18 is located higher than the exhaust camshaft 20.

The other end (upstream end) of the intake port 15 is connected to an intake device 21 on one side (the right side as viewed from the front of the engine) of the cylinder head 4 in the left-and-right direction. The intake device 21 includes a throttle valve 23 connected to the upstream end of the intake port 15 via a downstream intake air passage 22, and an air cleaner 25 connected to the throttle valve 23 via an upstream intake air passage 24. The throttle valve 23 is opened/closed in synchronism with an accelerator operation performed by the driver.

The other end (downstream end) of the exhaust port 16 is connected to an exhaust device (not shown) on the other side of the cylinder head 4 in the left-and-right direction.

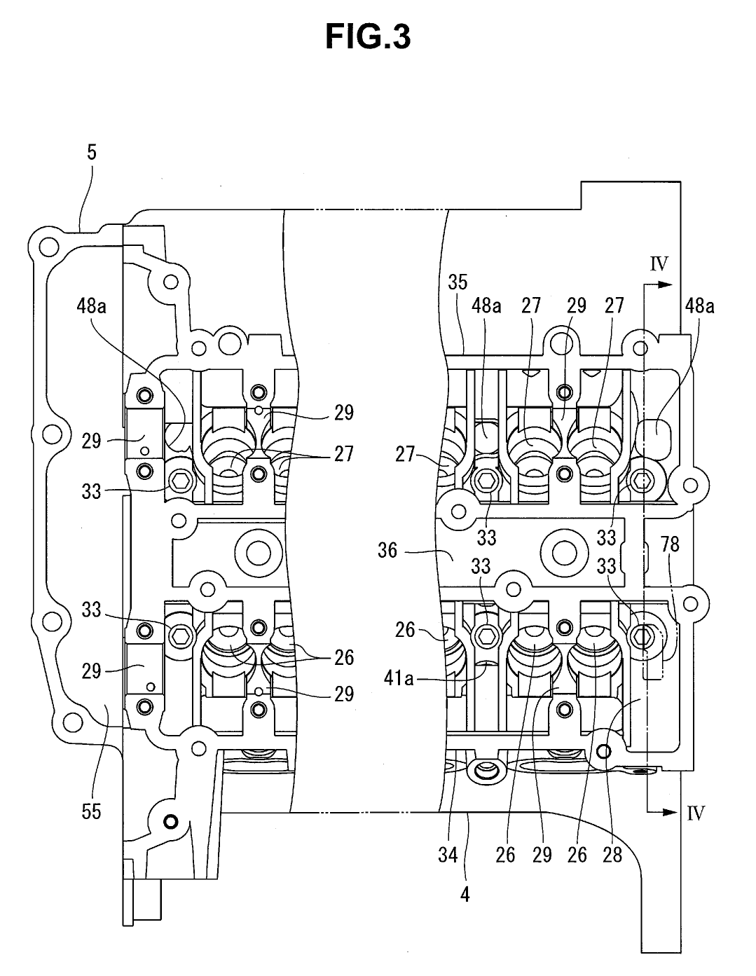

The intake valve 17 and the exhaust valve 19 preferably each include two valves per cylinder, for example. The intake valves 17 and exhaust valves 19 are inserted into intake valve holes 26 and exhaust valve holes 27 in the cylinder head 4 as shown in FIG. 3, and are movably supported therein. The holes 26 and 27 are located in a bottom wall 28 (to be described below) of the cylinder head 4.

As shown in FIG. 2, the intake camshaft 18 and the exhaust camshaft 20 extend parallel or substantially parallel to the crankshaft 12 and are rotatably supported by the cylinder head 4 with front ends (the ends on the front end of the engine) projecting from the cylinder head 4. The intake camshaft 18 and the exhaust camshaft 20 are supported by a plurality of journals 29 (see FIG. 3) provided in the cylinder head 4. The journals 29 are located where the intake camshaft 18 and the exhaust camshaft 20 project from the cylinder head 4 to the front end of the engine, between each pair of intake valve holes 26 in each cylinder, and between each pair of exhaust valve holes 27 in each cylinder.

The front ends of the intake camshaft 18 and the exhaust camshaft 20 projecting from the cylinder head 4 are connected to the crankshaft 12 via a transmission gear 31, as shown in FIG. 2. The transmission gear 31 transmits a rotation using a wrap transmission member 32 such as a timing chain or a timing belt. The transmission gear 31 is housed in the transmission case 5 attached to front ends of the cylinder block 3 and the cylinder head 4. The transmission case 5 preferably is box shaped or substantially box shaped and defines openings in two directions, that is, toward the upper side and toward the rear end of the engine. The opening of the transmission case 5 in the direction toward the upper side is closed by the head cover 8 (to be described below). The opening of the transmission case 5 in the direction toward the rear end of the engine is closed by the cylinder block 3 and the cylinder head 4.

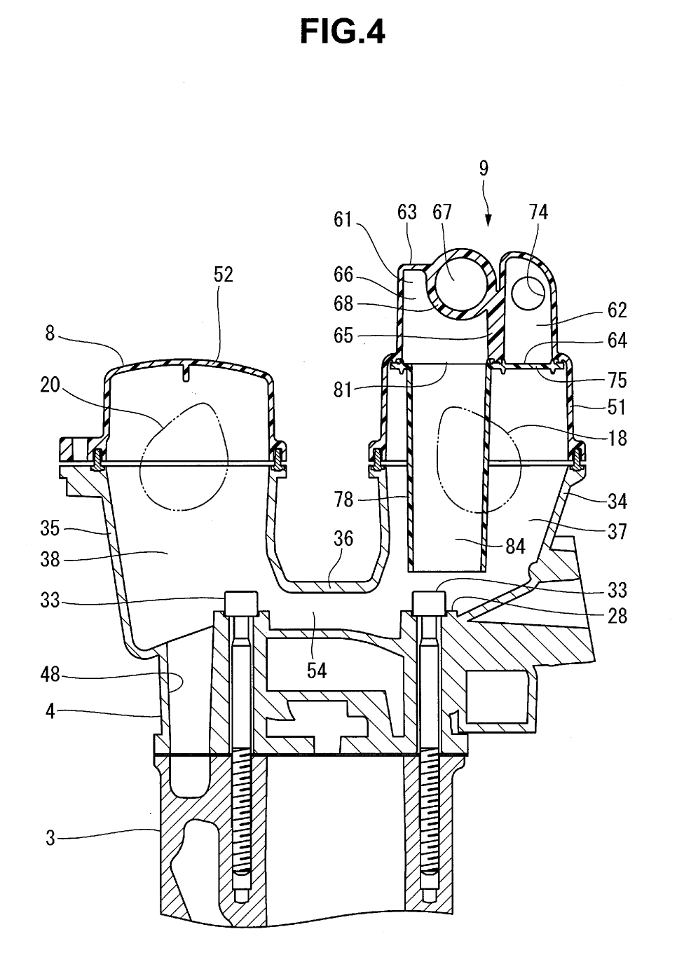

As shown in FIG. 4, the cylinder head 4 is fixed to the cylinder block 3 by a plurality of head bolts 33, for example, extending through the bottom wall 28. The head bolts 33 are screwed into the cylinder block 3 and extend through the bottom wall 28. The head bolts 33 are provided at a plurality of locations along the axial direction (the left-and-right direction in FIG. 3) of the crankshaft 12, as shown in FIG. 3, and on both sides in the left-and-right direction (the vertical direction in FIG. 3) perpendicular or substantially perpendicular to the axial direction of the crankshaft 12 and the cylinder axis C (see FIG. 1). The above-described plurality of locations in the axial direction of the crankshaft 12 include locations at the two ends of the cylinder head 4 and locations between the cylinders.

The cylinder head 4 according to the present preferred embodiment includes the bottom wall 28, an intake-side vertical wall 34 extending upward from the bottom wall 28 and surrounding the intake camshaft 18, an exhaust-side vertical wall 35 extending upward from the bottom wall 28 and surrounding the exhaust camshaft 20, and a ceiling wall 36 that connects the vertical walls 34 and 35, as shown in FIG. 4. The intake-side vertical wall 34 and the exhaust-side vertical wall 35 are preferably integral with the bottom wall 28. The head cover 8 (to be described below) is attached to the upper ends of the intake-side vertical wall 34 and the exhaust-side vertical wall 35. The bottom wall 28 and the intake-side vertical wall 34 define an intake-side valve gear chamber 37 together with the head cover 8. The bottom wall 28 and the exhaust-side vertical wall 35 define an exhaust-side valve gear chamber 38 together with the head cover 8.

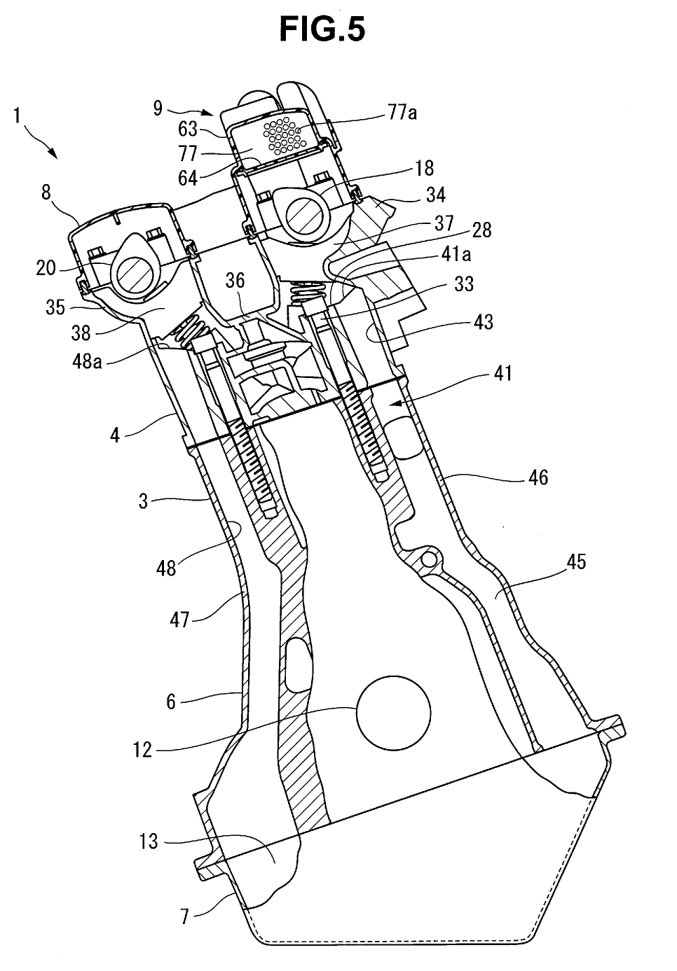

As shown in FIGS. 3 and 5, openings 41a at the downstream end of a communication path 41 are located adjacent to the head bolts 33 in a portion of the bottom wall 28 of the cylinder head 4 defining the intake-side valve gear chamber 37. The openings 41a at the downstream end of the communication path 41 are provided at a plurality of positions adjacent to the head bolts 33 between the cylinders. As shown in FIG. 2, the communication path 41 includes first to third branches 42 to 44 and an upstream portion 45. The first to third branches 42 to 44 extend parallel or substantially parallel to the cylinder axis C2 from the openings 41a at the downstream end to the side of the cylinder block 3. The upstream portion 45 connects the first to third branches 42 to 44 and extends in the cylinder block 3 toward the crank chamber 13.

As shown in FIG. 5, the upstream portion 45 is located along one side wall 46 of the cylinder block 3 in the left-and-right direction. The width of the upstream portion 45 in the axial direction of the crankshaft 12 is larger than the width of the engine 1 in the left-and-right direction (the thickness direction of the side wall 46). The upstream end (the lower end in FIG. 5) of the upstream portion 45 defines an opening in the crank chamber 13. For this reason, the intake-side valve gear chamber 37 communicates with the crank chamber 13 via the communication path 41.

An oil return passage 48 is provided on the other side wall 47 of the cylinder block 3. The lower end of the oil return passage 48 defines an opening in the crank chamber 13. The upper portion of the oil return passage 48 extends from the cylinder block 3 into the cylinder head 4. The upper end of the oil return passage 48 defines an opening in a portion of the bottom wall 28 of the cylinder head 4 defining the exhaust-side valve gear chamber 38. Openings 48a at the upper end of the oil return passage 48 are provided in the bottom wall 28 between the cylinders and at the two ends of the crankshaft 12 in the axial direction, as shown in FIG. 3. The openings 48a are located at the lowermost positions in the valve gear chambers (the intake-side valve gear chamber 37 and the exhaust-side valve gear chamber 38) between the cylinder head 4 and the head cover 8.

The head cover 8 is preferably molded into a predetermined shape using a plastic material, for example. In the head cover 8, as shown in FIG. 4, an intake-side cover 51 connected to the intake-side vertical wall 34, an exhaust-side cover 52 connected to the exhaust-side vertical wall 35, and a case cover 53 (see FIG. 2) connected to the upper end of the transmission case 5 are integral with each other.

The intake-side cover 51 defines the intake-side valve gear chamber 37 together with the intake-side vertical wall 34 and the bottom wall 28 of the cylinder head 4. The exhaust-side cover 52 defines the exhaust-side valve gear chamber 38 together with the exhaust-side vertical wall 35 and the bottom wall 28 of the cylinder head 4. As shown in FIG. 4, the intake-side valve gear chamber 37 and the exhaust-side valve gear chamber 38 communicate with each other via a communication chamber 54 located between the ceiling wall 36 and the bottom wall 28 of the cylinder head 4. In the present preferred embodiment, a series of spaces defined by the intake-side valve gear chamber 37, the exhaust-side valve gear chamber 38, and the communication chamber 54 define the valve gear chamber.

As shown in FIG. 2, the transmission case cover 53 of the head cover 8 is connected to the upper end of the transmission case 5. A transmission chamber 55 surrounded by the transmission case 5, the cylinder head 4, and the cylinder block 3 is located under the transmission case cover 53. The transmission gear 31 that transmits the rotation of the crankshaft 12 to the intake camshaft 18 and the exhaust camshaft 20 is housed in the transmission chamber 55. The front end of the cylinder head 4 on the front end of the engine is connected to the transmission chamber 55. The transmission chamber 55 communicates with the intake-side valve gear chamber 37 via the space above the intake camshaft 18 and also communicates with the exhaust-side valve gear chamber 38 via the space above the exhaust camshaft 20. Hence, the ends of the intake-side valve gear chamber 37 and the exhaust-side valve gear chamber 38 on the front end of the engine communicate with the crank chamber 13 via the transmission chamber 55.

As shown in FIG. 4, the intake-side cover 51 of the head cover 8 includes the gas-liquid separation device 9 for blow-by gas. The gas-liquid separation device 9 guides blow-by gas in the engine 1 to the intake device 21, and includes a gas-liquid separation chamber 61 that removes mist-like oil contained in the blow-by gas, and a fresh air chamber 62 that introduces fresh air into the crank chamber 13 to ventilate the engine 1.

The gas-liquid separation chamber 61 and the fresh air chamber 62 are located between a box body 63 that defines an opening in the direction toward the lower side and a cover body 64 that closes the opening of the box body 63. In the present preferred embodiment, the box body 63 corresponds to a main body that is integral with the head cover, and the cover body 64 corresponds to a cover body attached to the head cover. The box body 63 is integral with the rear end of the intake-side cover 51 on the rear end of the engine and projects toward the upper side of the front end (the end on the front end of the engine) of the intake-side cover 51.

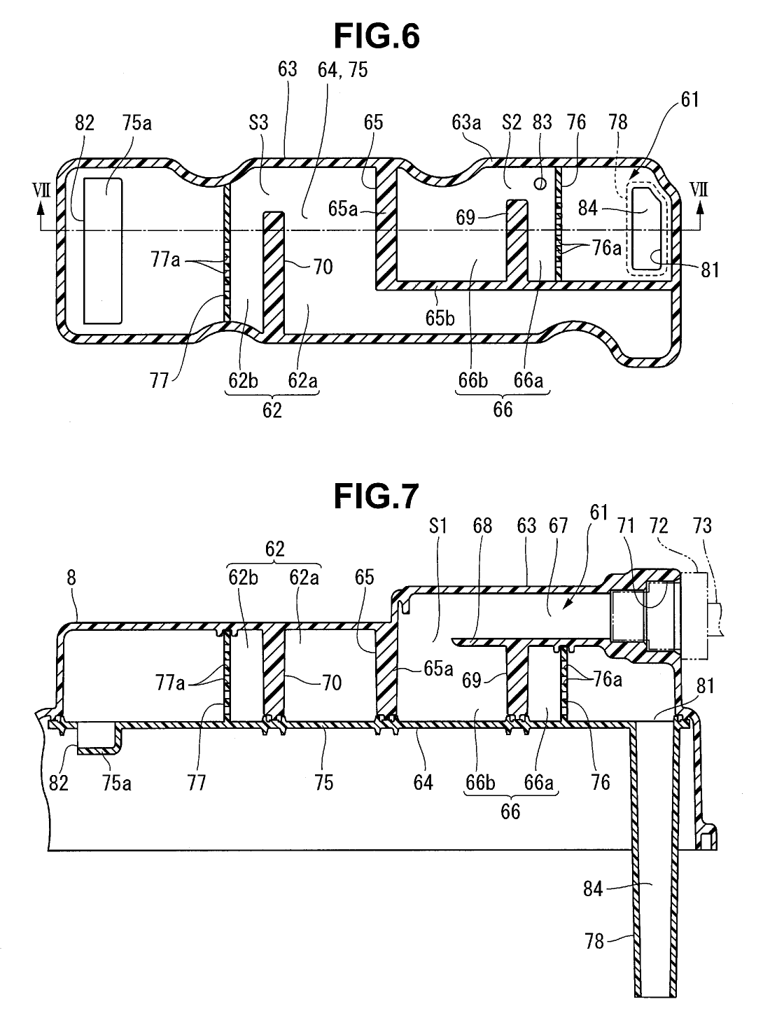

A partition 65 (see FIGS. 4 and 6), a first partition wall 68 (see FIGS. 4 and 7), a second partition wall 69 (see FIGS. 6 and 7), and a third partition wall 70 are provided in the box body 63. The partition 65 separates the gas-liquid separation chamber 61 and the fresh air chamber 62. The first partition wall 68 divides the gas-liquid separation chamber 61 into a lower chamber 66 and an upper chamber 67. The second partition wall 69 divides the lower chamber 66 into an upstream portion 66a and a downstream portion 66b. The third partition wall 70 divides the fresh air chamber 62 into an upstream portion 62a and a downstream portion 62b. The partition 65, the first partition wall 68, the second partition wall 69, and the third partition wall 70 are integral with the box body 63 by, for example, integral molding.

As shown in FIG. 6, the partition 65 includes a horizontal wall 65a and a vertical wall 65b. The horizontal wall 65a extends from the upper side portion (the upper side portion in FIG. 6) of the box body 63 close to the exhaust camshaft 20 into the box body 63 and divides the box body 63 in the axial direction of the crankshaft 12. The vertical wall 65b extends in the box body 63 from the distal end of the horizontal wall 65a to the rear end of the engine. Hence, the gas-liquid separation chamber 61 is provided in the box body 63 on the rear end of the engine and on one side close to the exhaust camshaft 20.

A blow-by gas outlet 71 is provided at the end of the upper chamber 67 of the gas-liquid separation chamber 61 on the rear end of the engine, as shown in FIG. 7. One end of a blow-by gas hose 73 is attached to the blow-by gas outlet 71 via a PCV (Positive Crankcase Ventilation) valve 72. The other end of the blow-by gas hose 73 is connected to the downstream intake air passage 22, as shown in FIG. 1. The PCV valve 72 opens when the magnitude of an intake negative pressure propagated from the downstream intake air passage 22 via the blow-by gas hose 73 exceeds a predetermined threshold. The upstream portion 62a (see FIG. 6) of the fresh air chamber 62 is located at a position adjacent to the upper chamber 67 of the gas-liquid separation chamber 61 in the left-and-right direction of the engine 1. A fresh air inlet 74 is provided at the end of the upstream portion 62a on the rear end of the engine, as shown in FIG. 4. The fresh air inlet 74 communicates with the upstream intake air passage 24 via a fresh air hose 74a (see FIG. 1).

As shown in FIG. 7, a gap S1 is provided between the first partition wall 68 and the horizontal wall 65a of the partition 65.

A gap S2 is provided between the distal end (see FIG. 6) of the second partition wall 69 and a side wall 63a of the box body 63.

A gap S3 is provided between the distal end of the third partition wall 70 and the side wall 63a of the box body 63.

As shown in FIGS. 4 and 7, the cover body 64 includes a main plate 75 that closes the opening of the box body 63, a first partition plate 76 and a second partition plate 77 which project upward from the main plate 75, and a duct 78 projecting downward from the end of the main plate 75 on the rear end of the engine. The main plate 75, the first partition plate 76, the second partition plate 77, and the duct 78 are preferably integral and made of a plastic material by, for example, integral molding. The cover body 64 is attached to the box body 63 by, for example, welding the main plate 75 to the box body 63.

As shown in FIGS. 6 and 7, a blow-by gas inlet 81 is provided at the end on the rear end of the engine in a portion of the main plate 75 defining the lower chamber 66 of the gas-liquid separation chamber 61. In addition, a fresh air outlet 82 is provided at the front end of the engine in a portion of the main plate 75 defining the downstream portion 62b of the fresh air chamber 62. The fresh air outlet 82 is provided in a passage 75a projecting downward from the main plate 75, and defines an opening in the upper portion of the intake-side valve gear chamber 37 in the direction toward the front end of the engine. As shown in FIG. 2, the fresh air outlet 82 is provided at a portion in the intake-side valve gear chamber 37 close to the transmission chamber 55.

The first partition plate 76 is located on the rear end of the engine (upstream side) with respect to the second partition wall 69 in the gas-liquid separation chamber 61, and divides the upstream portion 66a of the lower chamber 66 to the side of the blow-by gas inlet 81 and the side of the second partition wall 69. As shown in FIG. 6, an oil return hole 83 is provided in the main plate 75 between the first partition plate 76 and the second partition wall 69. The oil return hole 83 is located at a portion of the main plate 75, which is the lowest plate in a state in which the engine 1 is mounted in a vehicle body (not shown). As shown in FIG. 1, the engine 1 according to the present preferred embodiment is mounted in a vehicle body such that the exhaust-side valve gear chamber 38 is located lower than the intake-side valve gear chamber 37. For this reason, the oil return hole 83 is provided at the end of the main plate 75 close to the exhaust-side valve gear chamber 38.

A plurality of through holes 76a are provided in the first partition plate 76. In the present preferred embodiment, the first partition plate 76 and the above-described second partition wall 69 correspond to a partition wall.

The second partition plate 77 divides the downstream portion 62b of the fresh air chamber 62 to the side of the third partition wall 70 and the side of the fresh air outlet 82. A plurality of through holes 77a (see FIG. 5) are provided in the second partition plate 77 as well.

As shown in FIG. 4, the duct 78 extends downward from the blow-by gas inlet 81 of the gas-liquid separation chamber 61. The interior of the duct 78 defines a blow-by gas suction passage 84 connected to the blow-by gas inlet 81 and extends from the gas-liquid separation chamber 61 into the intake-side valve gear chamber 37. The lower end (the upstream end of the blow-by gas suction passage 84) of the duct 78 defines an opening near or adjacent to the bottom wall 28 through which the head bolts 33 extend in the cylinder head 4. The opening of the lower end of the duct 78 is preferably located between the intake camshaft 18 and the bottom wall 28 of the cylinder head 4 when viewed from the axial direction of the crankshaft 12, and preferably, near or adjacent to the head bolts 33. The opening of the lower end of the duct 78 opens toward the bottom wall 28.

As shown in FIG. 2, the lower end of the duct 78 is provided at a position spaced apart from the openings 41a at the downstream ends of the first to third branches 42 to 44 in the axial direction of the crankshaft 12. The lower end of the duct 78 according to the present preferred embodiment is located at the rear end (the end on the rear end of the engine) of the intake-side valve gear chamber 37 with one end connected to the transmission chamber 55 on the side opposite to the transmission chamber 55. For this reason, the blow-by gas suction passage 84 according to the present preferred embodiment is located at the end of the intake-side valve gear chamber 37 in the axial direction of the intake camshaft 18 at a position overlapping the intake camshaft 18 when viewed from the axial direction of the intake camshaft 18, as shown in FIG. 4.

In the gas-liquid separation device 9, at the time of engine operation, an intake negative pressure is propagated from the downstream intake air passage 22 to the PCV valve 72 via the blow-by gas hose 73. If the magnitude of the negative pressure exceeds a predetermined threshold, the PCV valve 72 opens, and the negative pressure is propagated into gas-liquid separation chamber 61. The negative pressure is propagated from the gas-liquid separation chamber 61 to the intake-side valve gear chamber 37 via the duct 78 (blow-by gas suction passage 84) and further propagated to the crank chamber 13 via the communication path 41.

On the other hand, at this time, since the negative pressure is also propagated from the fresh air outlet 82 in the intake-side valve gear chamber 37 to the upstream intake air passage 24 via the fresh air chamber 62 and the fresh air hose 74a, fresh air in the upstream intake air passage 24 is introduced from the fresh air outlet 82 into the intake-side valve gear chamber 37. The fresh air flows in the intake-side valve gear chamber 37 toward the transmission chamber 55 in the direction in which the fresh air outlet 82 is directed.

When the intake negative pressure is propagated from the communication path 41 to the crank chamber 13, the blow-by gas in the crank chamber 13 is drawn into the upstream portion 45 of the communication path 41. The blow-by gas contains an oil mist.

When the blow-by gas is thus drawn into the communication path 41, and the pressure in the crank chamber 13 is reduced, the gas containing fresh air in the intake-side valve gear chamber 37 flows into the crank chamber 13 via the transmission chamber 55. As a result, the crank chamber 13 is ventilated.

The blow-by gas drawn into the upstream portion 45 of the communication path 41 is drawn out from the upstream portion to the intake-side valve gear chamber 37 via the first to third branches 42 to 44 by the intake negative pressure. The blow-by gas drawn into the intake-side valve gear chamber 37 and the oil mist mixed therein directly advance to the opposite side of the cylinder block 3 due to momentum. The blow-by gas and the oil mist collide against the walls of the upper portion of the valve gear chamber defined by the cover body 64, the head cover 8, and the like and then turn toward the bottom of the intake-side valve gear chamber 37. At this time, the oil mist, which has a mass larger than that of the gas, is left behind and stays in the upper portion of the intake-side valve gear chamber 37, or is captured by the walls that the mist collides against. For this reason, the amount of oil mist mixed with the gas decreases. The gas and the oil mist which is turned by the upper portion of the intake-side valve gear chamber 37 flows toward the bottom of the valve gear chamber 37 and collides against the bottom wall 28 of the intake-side valve gear chamber 37. The oil mist is captured even when colliding against the bottom wall 28. As a result, the scattered amount of oil mist decreases in the vicinity of the bottom wall 28.

In the intake-side valve gear chamber 37, the intake camshaft 18 rotates at a high speed, and the oil mist is scattered from there by centrifugal force. Even when scattered toward the bottom wall of the intake-side valve gear chamber 37, the oil mist never directly enters the blow-by gas suction passage 84.

According to the present preferred embodiment, since the blow-by gas suction passage 84 extends in the intake-side valve gear chamber 37, and the upstream end of the blow-by gas suction passage 84 defines an opening near or adjacent to the bottom wall 28 of the valve gear chamber 37, blow-by gas containing only a little amount of oil mist is drawn into the blow-by gas suction passage 84.

The blow-by gas drawn into the blow-by gas suction passage 84 flows from the blow-by gas inlet 81 of the gas-liquid separation chamber 61 into the upstream portion 66a of the lower chamber 66 and passes through a number of through holes 76a in the first partition plate 76. At this time, a portion of the oil mist contained in the blow-by gas adheres to the first partition plate 76. The blow-by gas that has passed through the through holes 76a flows into the upper chamber 67 via the gap S2 between the second partition wall 69 and the box body 63 and the gap S1 between the first partition wall 68 and the partition 65. When the blow-by gas passes through the gaps S2 and S1, the direction of the flow of the blow-by gas is reversed. Hence, the particles of oil mist readily adhere to the side wall 63a of the box body 63 or the first partition wall 68 and the second partition wall 69.

The oil separated from the blow-by gas in the gas-liquid separation chamber 61 flows down from the oil return hole 83 to the intake-side valve gear chamber 37. In the intake-side valve gear chamber 37, oil scatters from the lubricated portion of the intake camshaft 18. The oil flowing down from the oil return hole 83 flows into the relatively low exhaust-side valve gear chamber 38 together with other oil in the intake-side valve gear chamber 37 and returns to the oil pan 7 via the oil return passage 48 in the exhaust-side valve gear chamber 38.

The blow-by gas flowing into the upper chamber 67 of the gas-liquid separation chamber 61 is drawn from the blow-by gas outlet 71 into the downstream intake air passage 22 via the PCV valve 72 and the blow-by gas hose 73.

If the rotational speed of the engine 1 reaches a high rotation/high load operation range, the throttle valve 23 fully opens. Hence, the pressure in the downstream intake air passage 22 increases, and the PCV valve 72 closes. In this operation state, the intake negative pressure may be propagated from the upstream intake air passage 24 to the intake-side valve gear chamber 37 via the fresh air chamber 62, and the blow-by gas in the intake-side valve gear chamber 37 may be drawn into the upstream intake air passage 24 via the fresh air chamber 62. In this case, the direction of the flow of the blow-by gas is changed by the second partition plate 77, the third partition wall 70, and the partition 65 provided in the fresh air chamber 62, and the oil mist contained in the blow-by gas adheres to these members and the inner wall of the fresh air chamber 62 and is captured.

The gas-liquid separation device 9 according to the present preferred embodiment uses a simple gas-liquid separation structure including only a plurality of partitions in the compact gas-liquid separation chamber 61 in the box body 63 and the cover body 64. Since the blow-by gas suction passage 84 connected to the blow-by gas inlet 81 of the gas-liquid separation chamber 61 defines an opening near or adjacent to the bottom wall 28 where the scattered amount of oil mist is small, the amount of oil mist drawn from the blow-by gas suction passage 84 into the gas-liquid separation chamber 61 decreases.

According to the present preferred embodiment, since the amount of oil mist drawn into the gas-liquid separation chamber 61 is small, the gas-liquid separation chamber 61 is made compact, and the structure is simplified.

Hence, according to the present preferred embodiment, it is possible to provide a gas-liquid separation device for blow-by gas in an engine that removes an oil mist contained in blow-by gas while using a compact and simple gas-liquid separation structure.

The upstream end of the blow-by gas suction passage 84 according to the present preferred embodiment opens near or adjacent to the bottom wall 28 and in a direction toward the bottom wall 28. For this reason, it is more difficult to draw the oil mist into the blow-by gas suction passage 84. It is therefore possible to provide a high performance gas-liquid separation device for blow-by gas.

The upstream end of the blow-by gas suction passage 84 is provided at a position spaced apart from the openings 41a of the communication path 41 on the downstream side in the axial direction of the crankshaft 12. It is therefore possible to prevent the blow-by gas drawn into the intake-side valve gear chamber 37 from being directly drawn into the blow-by gas suction passage 84.

The blow-by gas suction passage 84 according to the present preferred embodiment is provided at the end of the intake-side valve gear chamber 37 in the axial direction of the intake camshaft 18 at a position overlapping the intake camshaft 18 when viewed from the axial direction of the intake camshaft 18. For this reason, the oil mist scattered from the intake camshaft 18 that rotates at a high speed hardly enters the blow-by gas suction passage 84. It is therefore possible to further reduce the oil mist drawn into the gas-liquid separation chamber 61.

Additionally, in the present preferred embodiment, when the blow-by gas in the crank chamber 13 is drawn into the gas-liquid separation chamber 61 via the communication path 41, the intake-side valve gear chamber 37, and the blow-by gas suction passage 84, fresh air is introduced from the transmission chamber 55 to the crank chamber 13. Hence, it is possible to provide a gas-liquid separation device for blow-by gas in an engine that ventilates the crank chamber 13.

The gas-liquid separation chamber 61 according to the present preferred embodiment includes the box body 63 and the cover body 64 with the duct 78. For this reason, since the gas-liquid separation chamber 61 and the blow-by gas suction passage 84 are defined by combining members having simple shapes, it is possible to inexpensively provide a gas-liquid separation device for blow-by gas in an engine.

In the present preferred embodiment, the upstream end of the blow-by gas suction passage 84 opens at a location between the intake camshaft 18 and the bottom wall 28 when viewed from the axial direction of the crankshaft 12.

For this reason, the blow-by gas is drawn from an area where the scattered amount of oil mist is small into the blow-by gas suction passage 84. Hence, the amount of oil mist drawn from the blow-by gas suction passage 84 into the gas-liquid separation chamber 61 decreases.

In the above preferred embodiments, an example in which the gas-liquid separation device 9 for blow-by gas preferably is provided in a 4-cylinder engine 1 has been described. However, the gas-liquid separation device 9 for blow-by gas is not restricted by the number of cylinders. For this reason, the number of cylinders of the engine 1 may be appropriately changed.

The gas-liquid separation device is preferably located at the highest position in a state in which the engine is mounted in a vehicle. In a preferred embodiment, the gas-liquid separation device 9 is provided on the intake side. If the exhaust side is higher, the gas-liquid separation device 9 is preferably provided on the exhaust side.

The inventor of the preferred embodiments of the present invention considered that the gas-liquid separation chamber can be made compact if the amount of oil mist in the blow-by gas drawn in by the gas-liquid separation device is small. It was also discovered as a result of experiments that the amount of oil mist scattered in the valve gear chamber increases or decreases depending on the location. As a result of repetitive experiments, the present inventor discovered that the scattered amount of oil mist is small in the vicinity of the bottom wall of the valve gear chamber and conceived the idea of the present invention.

According to various preferred embodiments of the present invention, since the blow-by gas suction passage extends into the valve gear chamber, and the upstream end of the blow-by gas suction passage defines an opening near or adjacent to the bottom wall of the valve gear chamber, blow-by gas containing only a little amount of oil mist is introduced into the gas-liquid separation chamber. If the amount of oil mist drawn into the gas-liquid separation chamber is small, the gas-liquid separation chamber is able to be made compact, and the structure simplified.

The reason why the scattered amount of oil mist decreases in the vicinity of the bottom wall of the valve gear chamber is not clear. However, the following assumption is possible.

The blow-by gas drawn from the cylinder block side into the valve gear chamber by the action of the intake negative pressure and the oil mist mixed therein directly advance to the opposite side of the cylinder block due to momentum. The blow-by gas and the oil mist collide against the walls of the upper portion of the valve gear chamber defined by the bottom of the gas-liquid separation chamber, the head cover, and the like and then turn toward the bottom of the valve gear chamber. At this time, the oil mist, which has a mass larger than that of the gas, is left behind and stays in the upper portion of the valve gear chamber, or is captured by the walls that the mist collides against. For this reason, the amount of oil mist mixed in the gas decreases. The gas and the oil mist turned by the upper portion of the valve gear chamber flows toward the bottom of the valve gear chamber and collides against the bottom wall of the valve gear chamber. The oil mist is captured even when colliding against the bottom wall. As a result, the scattered amount of oil mist decreases in the vicinity of the bottom wall.

Note that in the valve gear chamber, the camshaft rotates at a high speed, and the oil mist is scattered therefrom by centrifugal force. Even when the oil mist is scattered toward the bottom wall of the valve gear chamber, it never directly enters the oil return passage.

Hence, according to preferred embodiments of the present invention, it is possible to provide a gas-liquid separation device for blow-by gas in an engine that removes an oil mist contained in blow-by gas while using a compact and simple gas-liquid separation structure.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A gas-liquid separation device for blow-by gas in an engine, the gas-liquid separation device comprising:
a head cover that defines a valve gear chamber together with a cylinder head;
a gas-liquid separation chamber in the head cover and including a blow-by gas inlet and a blow-by gas outlet;
a partition wall in the gas-liquid separation chamber that changes a direction of blow-by gas that flows between the blow-by gas inlet and the blow-by gas outlet; and
a blow-by gas suction passage connected to the blow-by gas inlet, and extending from the gas-liquid separation chamber to the valve gear chamber; wherein
an upstream end of the blow-by gas suction passage defines an opening in a vicinity of or adjacent to a bottom wall of the valve gear chamber.

2. The gas-liquid separation device according to claim 1, wherein the opening at the upstream end of the blow-by gas suction passage opens in a direction toward the bottom wall.

3. The gas-liquid separation device according to claim 1, wherein
the cylinder head includes an opening to a communication path that communicates a crank chamber with the valve gear chamber; and
the upstream end of the blow-by gas suction passage is spaced apart from the opening in the cylinder head in an axial direction of a crankshaft.

4. The gas-liquid separation device according to claim 1, wherein the blow-by gas suction passage is located at an end of the valve gear chamber in an axial direction of a camshaft at a position overlapping the camshaft when viewed from the axial direction of the camshaft.

5. The gas-liquid separation device according to claim 1, wherein
one end of the cylinder head in an axial direction of a crankshaft is connected to a transmission chamber that houses a transmission member that transmits a rotation of the crankshaft to a camshaft;
one end of the valve gear chamber in the axial direction of the crankshaft communicates with a crank chamber via the transmission chamber;
the head cover includes a fresh air chamber including a fresh air inlet and a fresh air outlet;
the fresh air inlet is connected to an intake air passage on a downstream side of an air cleaner;
the fresh air outlet is located in a portion of the valve gear chamber close to the transmission chamber; and
the upstream end of the blow-by gas suction passage is located at an end of the valve gear chamber on an opposite side of the transmission chamber.

6. The gas-liquid separation device according to claim 1, wherein the gas-liquid separation chamber includes:
a main body that is box-shaped or substantially box-shaped, opens in a direction toward the bottom wall, and is integral with the head cover; and
a cover body that closes the opening of the main body, and is attached to the head cover; wherein
the blow-by gas suction passage includes a duct in the cover body.

7. The gas-liquid separation device according to claim 1, wherein the upstream end of the blow-by gas suction passage that defines the opening is located between a camshaft and the bottom wall when viewed from an axial direction of a crankshaft.
